(19) United States
(12) Patent Application Publication
(10) Pub. No.: US 2017/0300964 A1
(43) Pub. Date: Oct. 19, 2017

(54) ESTIMATING THE FUTURE BOUNDS OF TIME-SENSITIVE METRICS

(71) Applicant: International Business Machines Corporation, Armonk, NY (US)

(72) Inventors: Aly Megahed, San Jose, CA (US); Hamid Reza Motahari Nezhad, San Jose, CA (US); Peifeng Yin, San Jose, CA (US)

(21) Appl. No.: 15/131,978

(22) Filed: Apr. 18, 2016

(51) Int. Cl. G06Q 30/02

(52) U.S. Cl. CPC G06Q 30/0247

(57) ABSTRACT

In one general embodiment, a computer-implemented method includes, for each time period of two or more time periods, calculating a variance of a metric based on one or more values of the metric for the time period. For each time period of the two or more time periods the following are calculated: a lower bound of a historical value and an upper bound of the historical value. A first curve is fit to the two or more lower bounds of historical values. A second curve is fit to the two or more upper bounds of historical values. For each of one or more future points in time, a future lower bound and a future upper bound for the future value of the metric at the future point in time are predicted utilizing the first curve and the second curve.

### BACKGROUND

The present invention relates to bound estimation, and more specifically, this invention relates to estimating the future bounds of various metrics.

Diversified sales pipeline metrics are designed to predict values that will be realized in the future. For example, a predicted conversion rate may predict a proportion of current pipeline values that are in a won stage. As another example, a predicted growth rate may predict the proportion of won values appearing in the future before the end of a given time period (e.g., month, quarter, year, etc.)

Complex methods may be used to predict these target values with historical pipeline metrics. However, these methods, when predicting the bounds of various metrics, are often affected by extreme/rate cases (e.g., outliers, etc.), and evaluate absolute historical values without consideration to more general trends that are relevant to the business.

### SUMMARY

A computer-implemented method according to one embodiment includes, for each time period of two or more time periods, calculating a variance of a metric based on one or more values of the metric for the time period. For each time period of the two or more time periods the following are calculated: a lower bound of a historical value based on one or more values of the metric and the variance for the time period, and an upper bound of the historical value based on the one or more values of the metric and the variance for the time period. A first curve is fit to the two or more lower bounds of historical values. A second curve is fit to the two or more upper bounds of historical values. For each of one or more future points in time, a future lower bound and a future upper bound for the future value of the metric at the future point in time are predicted utilizing the first curve and the second curve.

A computer program product for estimating future bounds of sales pipeline metrics includes a computer readable storage medium having program instructions embodied therewith, the program instructions executable by a computer to cause the computer to perform the foregoing method.

A system according to one embodiment includes a processor and logic integrated with and/or executable by the processor, the logic being configured to cause the system to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3A illustrates a method for estimating the future bounds of metrics, in accordance with one embodiment.

FIG. 3B illustrates an application of the method of FIG. 3A, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for estimating the future bounds of metrics.

In one general embodiment, a computer-implemented method includes, for each time period of two or more time periods, calculating a variance of a metric based on one or more values of the metric for the time period. For each time period of the two or more time periods the following are calculated: a lower bound of a historical value based on one or more values of the metric and the variance for the time period, and an upper bound of the historical value based on the one or more values of the metric and the variance for the time period. A first curve is fit to the two or more lower bounds of historical values. A second curve is fit to the two or more upper bounds of historical values. For each of one or more future points in time, a future lower bound and a future upper bound for the future value of the metric at the future point in time are predicted utilizing the first curve and the second curve.

In another general embodiment, a computer program product for estimating future bounds of sales pipeline metrics includes a computer readable storage medium having program instructions embodied therewith, the program instructions executable by a computer to cause the computer to perform the foregoing method.

In yet another general embodiment, a system includes a processor and logic integrated with and/or executable by the processor, the logic being configured to cause the system to perform the foregoing method.

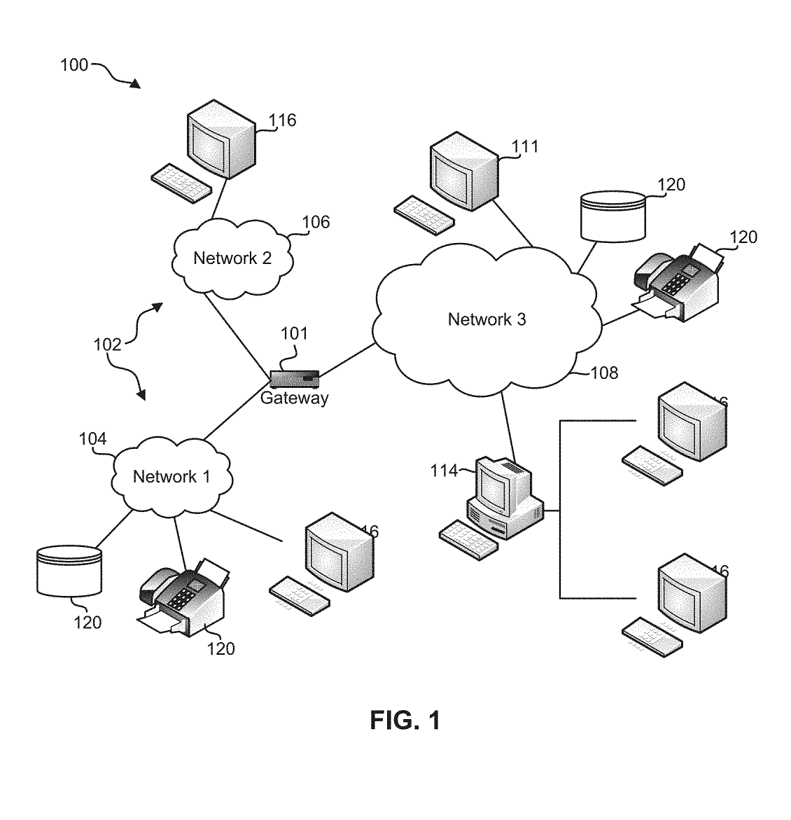

FIG. 1 illustrates an architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present architecture 100, the networks 104, 106 may each take any form including, but not limited to a LAN, a WAN such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. User devices 116 may also be connected directly through one of the networks 104, 106, 108. Such user devices 116 may include a desktop computer, lap-top computer, hand-held computer, printer or any other type of logic. It should be noted that a user device 111 may also be directly coupled to any of the networks, in one embodiment.

A peripheral 120 or series of peripherals 120, e.g., facsimile machines, printers, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX system which emulates an IBM z/OS environment, a UNIX system which virtually hosts a MICROSOFT WINDOWS environment, a MICROSOFT WINDOWS system which emulates an IBM z/OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used.

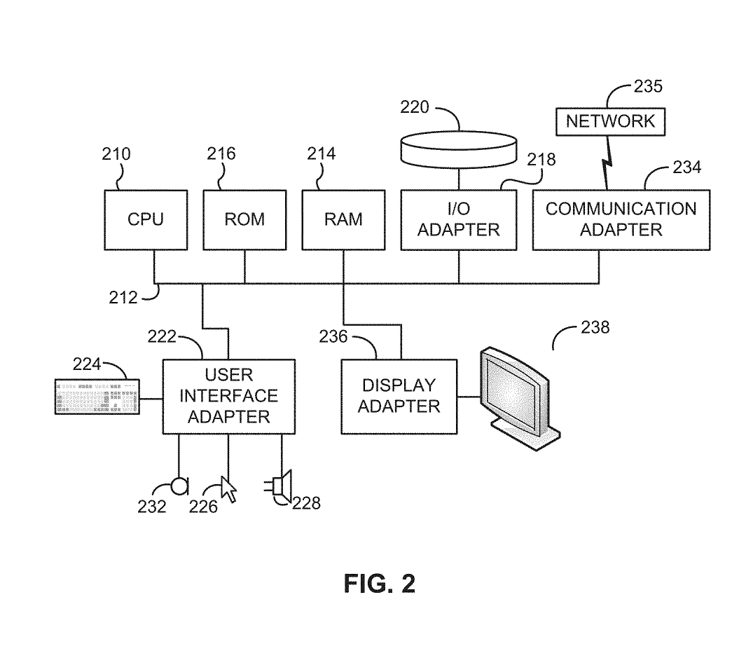

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), a MAC OS, a UNIX OS, etc. It will be appreciated that a preferred embodiment may also be implemented on platforms and operating systems other than those mentioned. A preferred embodiment may be written using XML, C, and/or C++ language, or other programming languages, along with an object oriented programming methodology. Object oriented programming (OOP), which has become increasingly used to develop complex applications, may be used.

Of course, this logic may be implemented as a method on any device and/or system or as a computer program product, according to various embodiments.

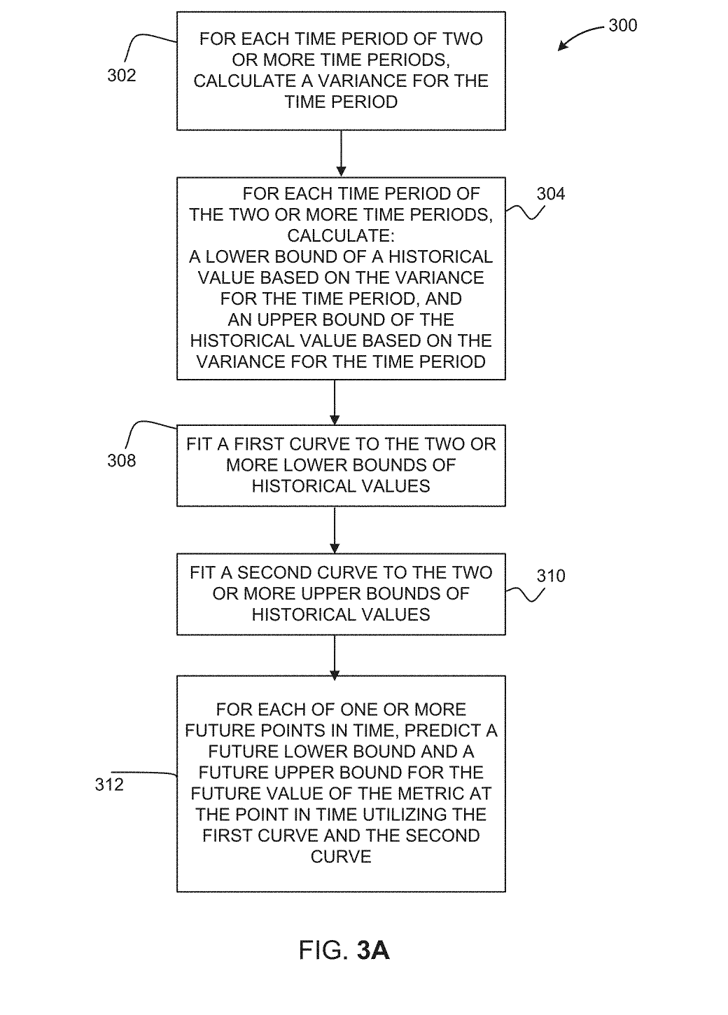

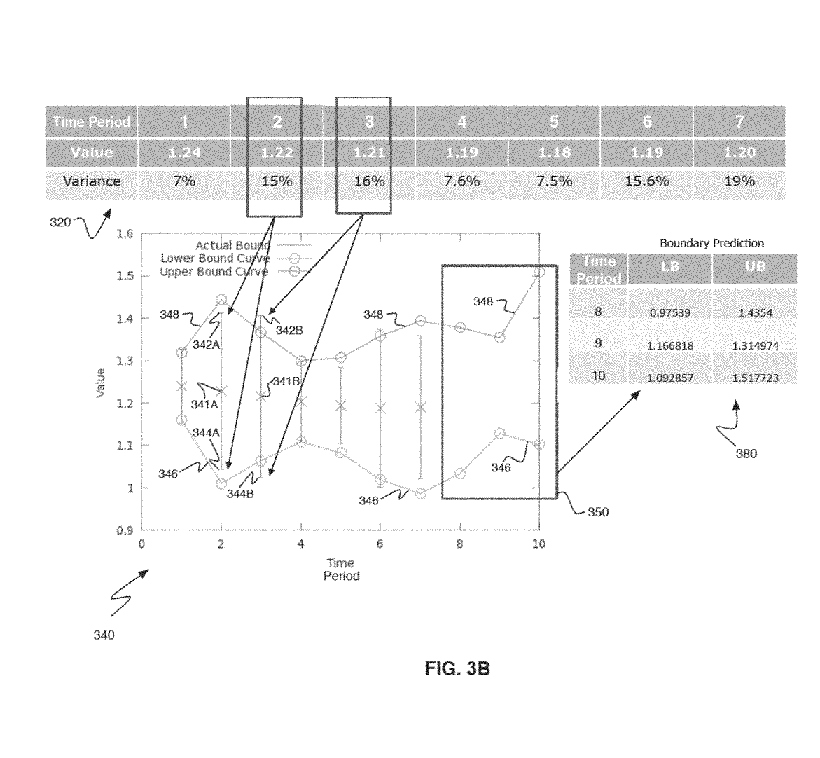

Now referring to FIG. 3A, a flowchart of a method 300 is shown according to one embodiment. The method 300 may be performed in accordance with the present invention in any of the environments depicted in FIGS. 1-2, among others, in various embodiments. Of course, more or less operations than those specifically described in FIG. 3A may be included in method 300, as would be understood by one of skill in the art upon reading the present descriptions.

Each of the steps of the method 300 may be performed by any suitable component of the operating environment. For example, in various embodiments, the method 300 may be partially or entirely performed by a processor, or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 3A, method 300 for estimating the future bounds of metrics initiates with operation 302, where, for each time period of two or more time periods, a variance is calculated for the time period. As used herein, a time period comprises any segment of time having a defined beginning and a defined ending. In one embodiment, the two or more time periods may be contiguous time periods of a larger unit of time. As an option, each time period may comprise an hour, a day, a week, a month, a quarter, a year, etc. For example, the two or more time periods may include a first time period comprising the first day of a week, a second time period comprising the second day of the week, and a third time period comprising the third day of the week. As another example, the two or more time periods may include a first time period comprising the first month of a year, a second time period comprising the second month of the year, and a third time period comprising the third month of the year. As still yet another example, the two or more time periods may include a first time period comprising the first quarter of a year, a second time period comprising the second quarter of the year, and a third time period comprising the third quarter of the year, etc. Of course, the above examples are intended to be non-limiting, and the time periods may span over one or more weeks, months, years, etc.

Still yet, the variance for a given time period comprises a measure of spread of one or more values that is associated with the time period. In one embodiment, the one or more values associated with the time period comprise measured or observed values of one or more metrics. For example, one or more measured values associated with a time period may comprise sales numbers, resource utilization rates, customer churn rates, etc. Accordingly, for each time period, a variance calculated for the time period may be representative of a spread of one or more values measured during the time period. Further, a different variance may be independently calculated for each of a plurality of time periods. As an option, each of the variances may be represented as a percentage (e.g., 0.2 or 20%, 0.16 or 16%, etc.). Of course, the variances may be represented in any suitable format.

In one embodiment, for each time period of the two or more time periods, the variance for the time period is calculated by applying a function to a series of values associated with the time period. In one approach, variance(vₜ)=func (f₁, f₂, . . . , fₙ), where t is the time period, (f₁, f₂, . . . , fₙ) is the series of values, and each of f₁, f₂, . . . , fₙ are values between 0 and 1.

In one embodiment, the function func (f₁, f₂, . . . , fₙ) may be defined as a function that averages the values of f₁, f₂, . . . , fₙ. In other embodiments, the func (f₁, f₂, . . . , fₙ) may be defined as a more sophisticated function. For example, the func (f₁, f₂, . . . , fₙ) may be defined as a weighted average function that gives different weights to different factors, without the loss of generality.

The measured value associated with each of the two or more time periods may be contextually attached to a set of conditions. For example, where the measured values include sales values, each sales value may be contextually attached to a set of business conditions that occurred contemporaneous with the time period during which, or for which, the sales value was measured. The conditions may provide a reason or basis for the measured value and calculated variance. For example, for a measured value that is contextually attached to a given time period (e.g., a day, week, month, quarter, year, etc.), a variance of the measured value may be affected by: an economic environment (e.g., the environment of the global economy, national economy, etc.) during the time period, the business environment (e.g., new product announcements, product retirements, etc.) during the time period, the estimated effort or rigor of a salesperson or sales team during the time period, the discipline of the salesperson or sales team with respect to updating the measured values during the time period, unreported information (e.g., a percentage of sales information that is systematically unreported, etc.) during the time period, and a difference of the time period from a prior time period.

Accordingly, each of the values of f₁, f₂, . . . , fₙ may be associated with one of the above influential factors. In other words, for each time period of the two or more time periods, each of the values in the series associated with the time period represents a factor with the associated value that is used in a function that defines variance for the value of the metric at the time period.

For example, where the future bounds of sales metrics are being estimated, a first factor, f₁, may be attributed a value that reflects the significance of the first factor (e.g., the environment of the global economy) in creating variance for a measured value during the time period that the measured value occurred. Similarly, a second factor, f₂, may be attributed a value that reflects the significance of the second factor (e.g., the business environment) in creating variance for the measured value during the time period that the value occurred. As a result, a value of variance(vₜ) may be different for each measured value, v, at given time t. In this way, different points in historical data may be modeled with variable variance.

In one embodiment, at least one of the values in each of the two or more series of values is input manually. In other words, one or more values in a series of values f₁, f₂, . . . , fₙ may be manually input by a user utilizing an input device (e.g., keyboard, mouse, smartphone, etc.). For example, a user may manually enter the value of the factor that reflects the significance of the environment of the global economy in creating variance for a measured sales value. As another example, a user may provide an estimation of a salesperson's or sales team's rigor and discipline for a given time period.

In one embodiment, at least one of the values in each of the two or more series of values is computed utilizing an external function. In other words, one or more values in a series of values f₁, f₂, . . . , fₙ may be computed by a processor based on a predetermined equation. For example, a predefined equation may calculate the value of the factor that reflects the significance of the business environment in creating variance for a measured value. As another example, the environment of the global economy during a time period may be calculated as a function of one or more share prices, and/or historical revenue trends of a target business line. Also, the business environment during a time period may be calculated as a function of the sentiments of positive and negative news coming out about the target business, and/or the company as a whole. Still yet, the difference in sales during a time period relative to one or more previous time periods may be calculated utilizing an external function. For example, the sales volume for a given brand may be computed relative to the same quarter in the prior year, previous four quarters, previous three years, etc.

In a further embodiment, some of the values in one or more of the two or more series of values are computed utilizing an external function and other values are input manually.

In this manner, the variance of a measured or observed value may be calculated for a given point in time as a function of various diverse and configurable influential factors.

In another embodiment, calculating the variance for a time period may include receiving a variance from a user. For example, rather than applying a function to a series of values associated with the time period, the variance for the time period may be input by a user. Further, the user may input the variances for one or more relevant time periods.

Now referring to FIG. 3B, the method 300 is shown applied to a sample data set, in accordance with one embodiment. In particular, a table 320 illustrates the calculation of a variance for a plurality of different time periods for which historical data has been collected. As described hereinabove, one or more of the variances may be received from a user, or one or more of the variances may be calculated by applying a function to a series of values associated with the respective time period. For example, for time period 1, a variance of 7% may be calculated by applying a function to a series of values associated with time period 1. Similarly, for time period 2, a variance of 15% may be calculated by applying the function to a series of values associated with time period 2. Also, for time period 3, a variance of 16% may be calculated by applying the function to a series of values associated with time period 3, and, for time period 4, a variance of 7.6% may be calculated by applying the function to a series of values associated with time period 4, etc. Still yet, a variance of 19% may be manually input by a user for association with time period 7. Accordingly, a different variance may be calculated for each respective time period.

In one embodiment, the measured values associated with the various time periods (i.e., value 1.24 for time period 1, value 1.22 for time period 2, etc.) are received in historical data. In other words, the historical data contains the measured or observed values for one or more previous time periods.

As an option, data preprocessing may be performed on the historical data. The data preprocessing may be performed before the variances are calculated for the time periods represented by the historical data. The data preprocessing may include any operation that affects the future lower and/or upper bounds predicted at operation 312, described in more detail below. For example, the data preprocessing may restrict a future bound from being predicted as less than 0. In other words, the data preprocessing may prevent the prediction of a negative value when only non-negative values may logically be predicted.

In one embodiment, the data preprocessing includes computing a logarithm of measured or observed values of the historical data. The logarithms may be computed when the unprocessed values of the historical data are non-negative and have no upper bound.

In another embodiment, the data preprocessing includes applying a sigmoid function to the measured or observed values of the historical data.

In yet another embodiment, the data preprocessing includes restricting the measured or observed values in the historical data to a metric range. As an option, the metric range may be provided by a user.

Referring again to FIG. 3A, at operation 304, for each time period of the two or more time periods, a lower bound of a historical value is calculated based on the variance for the time period, and an upper bound of the historical value is calculated based on the variance for the time period. Preferably, the lower bound of the historical value is calculated based on one or more values of the metric and the variance for the time period, and the upper bound of the historical value is calculated based on the one or more values of the metric and the variance for the time period.

As used herein, the upper bound for a time period comprises a value that is greater than or equal to every historical value measured or observed for the time period. Similarly, the lower bound for the time period comprises a value that is less than or equal to every historical value measured or observed for the time period.

Referring again to FIG. 3B, the operation 304 is shown applied to a sample data set, in accordance with one embodiment. In particular, a graph 340 illustrates the calculation of, for each time period of time periods 1-7, a lower bound of historical values, and an upper bound of historical values, based on the variance for the time period. For example, point 341A of the graph 340 is plotted at the value 1.22, observed for time period 2. Similarly, point 341B of the graph 340 is plotted at the value 1.21, observed for time period 3. As an option, the points 341 may represent mean values. For example, the value 1.22 represented by the point 341A may comprise a mean value calculated utilizing two or more values measured or observed at time period 2, and the value 1.21 represented by the point 341B may comprise a mean value calculated utilizing two or more values measured or observed at time period 3.

Moreover, for each of the time periods 1-7, respective upper bounds and respective lower bounds have been calculated. Specifically, upper bounds 342 and lower bounds 344 are shown plotted in the graph 340. More specifically, the upper bound 342A and the lower bound 344A have been calculated for time period 2, and the upper bound 342B and the lower bound 344B have been calculated for the time period 3. As described above, the upper bound 342A and the lower bound 344A for time period 2 may be calculated based on the 15% variance calculated for time period 2; and the upper bound 342B and the lower bound 344B for time period 3 may be calculated based on the 16% variance calculated for time period 3.

Referring again to FIG. 3A, at operation 308, a first curve is fit to the two or more lower bounds of historical values, and, at operation 310, a second curve is fit to the two or more upper bounds of historical values. In one embodiment, the first curve may be fit to the lower bounds of historical values by minimizing a function. Similarly, the second curve may be fit to the upper bounds of historical values by minimizing a function. The function minimized when fitting the second curve to the upper bounds of historical values may be the same function that is minimized when fitting the first curve to the lower bounds of historical values.

In one specific embodiment, the function may comprise the objective function of:

$$L ( w , X ) = {\sum }_{i = 1}^{N} ( {x}_{i} - {\sum }_{j = 0}^{n} {w}_{j} \cdot {t}^{j} ) + λ {\sum }_{j = 0}^{n} {w}_{j}^{2} .$$

In such an embodiment, for a multinomial curve of order n, fitting the curve includes finding proper parameters w₀, w₁, . . . , wₙ to minimize the objective function. In such an embodiment, X denotes a historical value (e.g., a historical pipeline metric, etc.), t denotes the corresponding time period, and λ is a predefined parameter. The predefined parameter λ may be adjusted to avoid over fit of the curve. As an option, the value of λ may be a predefined value that ranges from 0.01 to 1.

A polynomial order for each of the curves may be determined based on a trade-off between the curve fitness (fitness of the curve for the data) and the exponential penalty for model complexity discounted by the number of available data points. The exponential penalty for model complexity may be computed using known techniques.

For example, determining a proper polynomial order for a fit curve may include accounting for both a number of available data points (i.e., number of measured values for the time periods), and a fitness of the curve for the data. In various embodiments, the fitness of the curve may be determined utilizing a defined objective function, mean absolute error (MAE), Akaike's information criterion (AIC), and/or Bayesian information criterion (BIC).

In one embodiment, Fit(n, X) denotes the fitness score of the polynomial order, n, on the data. A proper n may be determined by minimizing the metric of:

$$\frac{{n}^{a}}{N} Fit ( n , X ) ,$$

where α is a predefined positive value that controls a penalty for a high polynomial order, and N is the number of data points that the curve is being fit to. As an option, the value of a may be input or otherwise configured by a user. Accordingly, the use of a higher order polynomial or lower order polynomial may be determined based on the data. Use of a lower order polynomial may be preferred unless an identified higher order polynomial is determined to be sufficiently fit, or if there are a significant number of data points. As an option, the first curve fit to the lower bounds of historical values may have a different polynomial order than the second curve fit to the upper bounds of historical values.

Further still, at operation 312, for each of one or more future points in time, a future lower bound and a future upper bound for the future value of the metric at the future point in time is predicted utilizing the first curve and the second curve. As used herein, a future point in time includes any time period that is outside of the two or more time periods for which a variance was calculated. As an option, a future time period may comprise a time period that has not yet occurred. For example, at operation 302, a variance may be calculated for each quarter of eight quarters occurring over a two year span. In such an example, at operation 312, each of the future points in time may comprise a quarter for which data is not yet available (e.g., the data is not complete, the quarters have not yet occurred, etc.).

Still yet, the future lower bound for a future point in time comprises a value that is less than or equal to every historical value expected to occur in a set of values for the time period. Similarly, the future upper bound for the future point in time comprises a value that is greater than or equal to every historical value expected to occur in the set of values for the time period. In one embodiment, the set of values for a future time period may comprise a single value, such as, for example, a predicted sales value, a mean value, etc. Accordingly, the single value for the future point in time is expected to be fully bounded by the predicted future upper bound and the predicted future lower bound of the future point in time.

Referring again to FIG. 3B, the operations 308-312 of method 300 are shown applied to a sample data set, in accordance with one embodiment. In particular a first curve 346 is fit to the two or more lower bounds of historical values, and a second curve 348 is fit to the two or more upper bounds of historical values. Moreover, for each of one or more future points in time 350, a future lower bound and a future upper bound for the future point in time is predicted utilizing the first curve 346 and the second curve 348.

In particular, a future lower bound and a future upper bound are predicted utilizing the first curve 346 and the second curve 348, respectively, for each of the future points in time comprising time periods 8, 9, and 10. More specifically, utilizing the first curve 346: a future lower bound of 0.97539 has been predicted for the future point in time comprising time period 8, a future lower bound of 1.166818 has been predicted for the future point in time comprising time period 9, and a future lower bound of 1.092857 has been predicted for the future point in time comprising time period 10. Moreover, utilizing the second curve 348: a future upper bound of 1.4354 has been predicted for the future point in time comprising time period 8, a future upper bound of 1.314974 has been predicted for the future point in time comprising time period 9, and a future upper bound of 1.517723 has been predicted for the future point in time comprising time period 10. The predicted lower bounds and the predicted upper bounds for time periods 8-10 are also provided in a table 380 of FIG. 3B. It should be noted that the predicted lower and upper bounds vary in a time-aware manner, such that the predicted lower and upper bounds vary between the future time periods.

In one embodiment, and as described above, the method 300 may be applied in the context of predicting future sales metrics in a sales pipeline. For example, the values observed at time periods 1-7 may be representative of sales figures (e.g., $1.24M for time period 1, $1.22M for time period 2, $1.21M for time period 3, $1.19M for time period 4, etc.). Accordingly, the bound predictions for time periods 8-10 predict the upper bounds and lower bounds for sales figures during the respective future time periods. This exemplary context is provided for illustrative purposes only, and should not be construed as limiting in any manner.

In particular, it is contemplated that the method 300 may be utilized for estimating the future bounds of metrics in various diverse contexts. As an option, the observed values may comprise resource utilization values, and the method 300 may be utilized for planning for capacity needs by estimating the bounds of future resource utilization based on resource utilization history, such as, for example, in a multi-tenant client-server cloud architecture. As another option, the observed values may comprise customer churn rates, and the method 300 may be utilized for estimating the future churn of customers, such as, for example, in a service or sales context. As yet another option, the measured values may comprise the movement (e.g., sale, etc.) of product units, and the method 300 may be utilized for estimating a future product pipeline, such as, for example, a number of units expected to sell during a given future time period.

The function and/or factors utilized to determine the variance for a time period may depend upon the use context of the method 300. In other words, although a function and a set of business conditions are set forth above as being attached to sales values, the use of other functions and factors are contemplated. For example, where the method 300 is utilized to estimate the bounds of future resource utilization, conditions impacting resource utilization variance may include cloud services publicity, IT security news, bandwidth costs, etc.

In this manner, the method 300 may provide a general, time-aware, and scientific approach for predicting the acceptable future bound values of different metrics, such as, for example, sales pipeline metrics, resource utilization metrics, customer churn metrics, product pipeline metrics, etc. The method 300 may be utilized for identifying the future bounds of business expectations. Also, the method 300 provides a framework for identifying outlier predicted values, and normalizing those predictions to values within the bounds acceptable for the given metric. In other words, utilizing the method 300, the future bounds of metrics may be identified, and the bounds are not affected by extreme/rate cases (i.e., are immune to outliers). Moreover, by accounting for general trends that impact the business/data, the method 300 extends beyond performing simple computation on absolute historical values.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A computer-implemented method, comprising:
for each time period of two or more time periods, calculating a variance of a metric based on one or more values of the metric for the time period;
for each time period of the two or more time periods, calculating:
a lower bound of a historical value based on one or more values of the metric and the variance for the time period, and
an upper bound of the historical value based on the one or more values of the metric and the variance for the time period;
fitting a first curve to the two or more lower bounds of historical values;
fitting a second curve to the two or more upper bounds of historical values; and
for each of one or more future points in time, predicting a future lower bound and a future upper bound for the future value of the metric at the future point in time utilizing the first curve and the second curve.

2. The computer-implemented method of claim 1, wherein, for each time period of the two or more time periods, the variance of the metric for the time period is calculated by applying a function to a series of values associated with the time period.

3. The computer-implemented method of claim 2, wherein, for each time period of the two or more time periods, each of the values in the series associated with the time period represents a factor with the associated value that is used in a function that defines variance for the value of the metric at the time period.

4. The computer-implemented method of claim 3, wherein the values in the two or more series of values are input manually, computed utilizing an external function, or in part input manually and in part computed utilizing an external function.

5. The computer-implemented method of claim 3, wherein the factors include one or more of: an economic environment, a business environment, an estimated effort, un-reported information, and a difference from a prior time period.

6. The computer-implemented method of claim 2, wherein fitting the first curve to the two or more lower bounds of historical values and fitting the second curve to the two or more upper bounds of historical values includes finding parameters w₀, w₁, . . . , wₙ to minimize an objective function of:
$$L ( w , X ) = {\sum }_{i = 1}^{N} ( {x}_{i} - {\sum }_{j = 0}^{n} {w}_{j} \cdot {t}^{j} ) + λ {\sum }_{j = 0}^{n} {w}_{j}^{2} ,$$
wherein X comprises historical metrics, t comprises the time period, and λ comprises a predefined value between 0.01 and 1.

7. The computer-implemented method of claim 1, comprising determining a polynomial order for each of the curves based on a trade-off between a curve fitness and an exponential penalty for model complexity discounted by a number of available data points.

8. A computer program product for estimating future bounds of sales pipeline metrics, the computer program product comprising a computer readable storage medium having program instructions embodied therewith, the program instructions executable by a computer to cause the computer to:
for each time period of two or more time periods, calculate, by the computer, a variance of a metric based on one or more values of a metric for the time period;
for each time period of the two or more time periods, calculate, by the computer:
a lower bound of a historical value based on one or more values of the metric and the variance for the time period, and
an upper bound of the historical value based on the one or more values of the metric and the variance for the time period;
fit, by the computer, a first curve to the two or more lower bounds of historical values;
fit, by the computer, a second curve to the two or more upper bounds of historical values; and
for each of one or more future points in time, predict, by the computer, a future lower bound and a future upper bound for the future value of the metric at the future point in time utilizing the first curve and the second curve.

9. The computer program product of claim 8, wherein, for each time period of the two or more time periods, the variance of the metric for the time period is calculated by applying a function to a series of values associated with the time period.

10. The computer program product of claim 9, wherein, for each time period of the two or more time periods, each of the values in the series associated with the time period represents a factor with the associated value that is used in a function that defines variance for the value of the metric at the time period.

11. The computer program product of claim 10, wherein the values in the two or more series of values are input manually, computed utilizing an external function, or in part input manually and in part computed utilizing an external function.

12. The computer program product of claim 10, wherein the factors include one or more of: an economic environment, a business environment, an estimated effort, un-reported information, and a difference from a prior time period.

13. The computer program product of claim 8, wherein fitting the first curve to the two or more lower bounds of historical values and fitting the second curve to the two or more upper bounds of historical values includes finding parameters w₀, w₁, . . . , wₙ to minimize an objective function of:
$$L ( w , X ) = {\sum }_{i = 1}^{N} ( {x}_{i} - {\sum }_{j = 0}^{n} {w}_{j} \cdot {t}^{j} ) + λ {\sum }_{j = 0}^{n} {w}_{j}^{2} ,$$
wherein X comprises historical metrics, t comprises the time period, and λ comprises a predefined value between 0.01 and 1.

14. The computer program product of claim 8, comprising program instructions executable by the computer to cause the computer to determine a polynomial order for each of the curves based on a trade-off between a curve fitness and an exponential penalty for model complexity discounted by a number of available data points

15. A system, comprising:
a processor and logic integrated with and/or executable by the processor, the logic being configured to:
for each time period of two or more time periods, calculate a variance of a metric based on one or more values of a metric for the time period;
for each time period of the two or more time periods, calculate:
a lower bound of a historical value based on one or more values of the metric and the variance for the time period, and
an upper bound of the historical value based on the one or more values of the metric and the variance for the time period;
fit a first curve to the two or more lower bounds of historical values;
fit a second curve to the two or more upper bounds of historical values; and
for each of one or more future points in time, predict a future lower bound and a future upper bound for the future value of the metric at the future point in time utilizing the first curve and the second curve.

16. The system of claim 15, wherein, for each time period of the two or more time periods, the variance of the metric for the time period is calculated by applying a function to a series of values associated with the time period.

17. The system of claim 16, wherein, for each time period of the two or more time periods, each of the values in the series associated with the time period represents a factor with the associated value that is used in a function that defines variance for the value of the metric at the time period.

18. The system of claim 15, wherein the logic is configured to determine a polynomial order for each of the curves based on a trade-off between a curve fitness and an exponential penalty for model complexity discounted by a number of available data points.
